(19) United States
(12) Patent Application Publication
(10) Pub. No.: US 2020/0358844 A1
(43) Pub. Date: Nov. 12, 2020

(54) SERVER AND METHOD FOR SHARING COLLABORATIVE EDITING FILE

(71) Applicant: Tmax A&C Co., Ltd., Seongnam-si (KR)

(72) Inventor: Seunggil LEE, Seongnam-si (KR)

(21) Appl. No.: 16/502,991

(22) Filed: Jul. 3, 2019

(30) Foreign Application Priority Data
May 10, 2019 (KR) 10-2019-0055092

(51) Int. Cl. H04L 29/08

(52) U.S. Cl. CPC H04L 67/10; H04L 67/24

(57) ABSTRACT

Disclosed is a computer program stored in a non-transitory computer readable medium, in which the computer program includes commands which cause a server to execute steps and the steps include: receiving a first signal requesting access to a first file associated with a first program from a first user terminal; if the first signal is received, checking whether a second user terminal is accessing the first file; determining a method for generating a first window in the first program, in which the first window is assigned to the first user terminal, based on whether the second user terminal is accessing the first file; generating a first image for a first area associated with the first window among an entire execution screen in which the first file is loaded through the first program; and transmitting the first image to the first user terminal.

### CROSS-REFERENCE TO RELATED APPLICATIONS

This application claims priority to and the benefit of Korean Patent Application No. 10-2019-0055092 filed in the Korean Intellectual Property Office on May 10, 2019, the entire contents of which are incorporated herein by reference.

### TECHNICAL FIELD

The present disclosure relates to a server and a method for sharing a collaborative editing file.

### BACKGROUND ART

With the development of computer technology, various programs are being distributed for easy and simple creation of an office task. In addition, a user can conveniently perform a task by selecting a program that matches himself/herself among various programs.

However, when the user shares a file created through a specific program installed in a user terminal with another user, a recipient may have difficulty in accessing a file shared by the user unless a specific program is installed in a terminal of a recipient.

In this case, the recipient must separately install a specific program on the terminal of the recipient to access the shared file. Otherwise, the recipient may have to request the user who provides the file to convert the file into a format that can be executed by the program possessed by the user.

Some of the programs may be free, but most are operated for a fee. In other words, a user may have to pay for purchasing a program which the user does not normally use for business collaboration with other users. The cost can be burdensome to the individual as well as the enterprise or government.

### SUMMARY OF THE INVENTION

The present disclosure has been made in an effort to provide a method which enables a collaborative editing file to be conveniently shared.

However, technical objects of the present disclosure are not restricted to the technical object mentioned as above. Unmentioned technical objects will be apparently appreciated by those skilled in the art by referencing to the following description.

An exemplary embodiment of the present disclosure provides a computer program stored in a computer-readable storage medium.

In the computer program stored in a non-transitory computer readable medium, the computer program includes commands which cause a server to execute steps and the step may include: receiving a first signal requesting access to a first file associated with a first program from a first user terminal; if the first signal is received, checking whether a second user terminal is accessing the first file; determining a method for generating a first window in the first program, in which the first window is assigned to the first user terminal, based on whether the second user terminal is accessing the first file; generating a first image for a first area associated with the first window among an entire execution screen in which the first file is loaded through the first program; and transmitting the first image to the first user terminal.

The determining of a method for generating a first window allocated to the first user terminal in the first program based on whether the second user terminal is accessing the first file may include: if the second user terminal is not accessing the first file, executing the first program associated with the first file; loading the first file through the first program; and generating the first window to be assigned to the first user terminal in the first program loaded with the first file.

The determining of a method for generating a first window in the first program based on whether the second user terminal is accessing the first file may include: if the second user terminal is accessing the first file, generating the first window to be assigned to the first user terminal in the first program being executed as the second user terminal accesses the first file.

The steps may further include transmitting a second image of a second area associated with a second window assigned to the second user terminal among the entire execution screens to the second user terminal.

The steps may further include: receiving a second signal including a first event modifying a first object included in the first area from the first user terminal; and applying the first event to the first file upon receiving the second signal.

The applying the first event to the first file upon receiving the second signal may include modifying the first object included in the entire execution screen.

The steps may further include if the first event is applied in the first file, transmitting first information about a modified section within the first area and a first section image associated with the modified section within the first area to the first user terminal.

The first information may include information related to at least one of positional information, size information, and format information in which the modified section is disposed in the first area.

The first event may include at least one of an event editing the first object, an event moving the first object or an event deleting the first object.

The steps may further include: receiving a third signal including a second event requesting to display the first image on the second user terminal from the first user terminal; and transmitting the first image instead of the second image to the second user terminal upon receiving the third signal.

The transmitting of the first image instead of the second image to the second user terminal by receiving the third signal may include: transmitting a fourth signal for confirming, to the second user terminal, whether to display the first image corresponding to the third signal to the second user terminal; and when receiving a fifth signal to display the first image in response to the fourth signal from the second user terminal, transmitting the first image instead of the second image to the second user terminal.

Another exemplary embodiment of the present disclosure provides a server which may include: a communication unit receiving a first signal requesting access to a first file associated with a first program from a first user terminal; and a processor checking whether a second user terminal is accessing the first file when the first signal is received, in which the processor may be further configured to: determine a method for generating a first window in the first program; generate a first image for a first area associated with the first window among an entire execution screen in which the first file is loaded through the first program; and control the communication unit to transmit the first image to the first user terminal, and the first window is assigned to the first user terminal based on whether the second user terminal is accessing the first file.

The processor may be further configured to: if the second user terminal is not accessing the first file, execute the first program associated with the first file, load the first file through the first program, and generate the first window to be assigned to the first user terminal in the first program loaded with the first file.

The processor may be further configured to: if the second user terminal is accessing the first file, generate the first window to be assigned to the first user terminal in the first program being executed as the second user terminal accesses the first file.

The processor may be further configured to: control the communication unit to transmit a second image of a second area associated with a second window assigned to the second user terminal among the entire execution screens to the second user terminal.

The processor may be further configured to: receive a second signal including a first event modifying a first object included in the first area from the first user terminal through the communication unit, and apply the first event to the first file upon receiving the second signal.

The processor may be further configured to: control the communication unit to transmit first information about a modified section within the first area and a first section image associated with the modified section within the first area to the first user terminal if the first event is applied in the first file.

The first information may include information related to at least one of positional information, size information, and format information in which the modified section is disposed in the first area.

The first event may include at least one of an event editing the first object, an event moving the first object or an event deleting the first object.

The processor may be further configured to: receive a third signal including a second event requesting to display the first image on the second user terminal from the first user terminal through the communication unit, control the communication unit to transmit a fourth signal for confirming to the second user terminal whether to display the first image corresponding to the third signal to the second user terminal, and control the communication unit to transmit the first image instead of the second image to the second user terminal when receiving a fifth signal to display the first image in response to the fourth signal from the second user terminal.

Technical solving means which can be obtained in the present disclosure are not limited to the aforementioned solving means and other unmentioned solving means will be clearly understood by those skilled in the art from the following description.

According to an exemplary embodiment of the present disclosure, a collaborative editing file can be conveniently shared.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 illustrates an exemplary system for sharing a collaborative editing file according to some exemplary embodiments of the present disclosure.

FIG. 2 is a flowchart for describing an example of a method for providing data by a server according to some exemplary embodiments of the present disclosure.

FIG. 3 is a flowchart for describing an example of a method for creating a first window that is assigned to a first user terminal according to some exemplary embodiments of the present disclosure in a first program.

FIG. 4 is a flowchart for describing an example of an operation of a server which modifies a first image related to a first file according to some exemplary embodiments of the present disclosure.

FIG. 5 is a diagram for describing an example of an area that may be displayed in a user terminal according to some exemplary embodiments of the present disclosure.

FIG. 6 is a diagram for describing an example of a method for modifying an object by a user terminal according to some exemplary embodiments of the present disclosure.

FIG. 7 is a flowchart for describing an example of a method for transmitting a first image to a second user terminal according to a request of a first user by a server according to some exemplary embodiments of the present disclosure.

FIG. 8 is a diagram for describing an example of a method for changing an area transmitted to a second user terminal by a server according to some exemplary embodiments of the present disclosure.

FIG. 9 is a general schematic view of an exemplary computing environment in which exemplary embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

The word “comprises” and/or “comprising” means that the corresponding feature and/or component is present, but it should be appreciated that presence or addition of one or more other features, components, and/or a group thereof is not excluded. Further, when not separately specified or not clear in terms of the context that a singular form is indicated, it should be construed that the singular form generally means “one or more” in the present specification and the claims.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

The scope of the claims for the method in the claims of the present disclosure arises from the functions and features described in each step and is not affected by the order in which each step in the claims disclosed if a sequence relationship of the disclosure order in respective steps constituting the method is not specified. For example, in the claims set forth in the method including steps A and B, the scope of rights is not limited to the fact that step A precedes step B, even if step A is described before step B.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

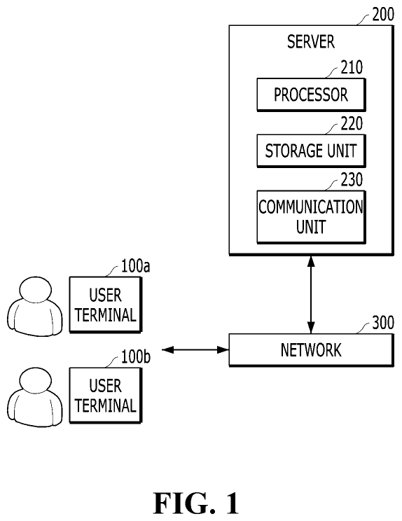

FIG. 1 illustrates an exemplary system for sharing a collaborative editing file according to some exemplary embodiments of the present disclosure.

Referring to FIG. 1, the collaborative editing file sharing system may include a user terminal 100, a server 200, and a network 300. However, components described above are not required in implementing the data conversion system and the collaborative editing file sharing system may thus have components more or less than components listed above.

The user terminal 100 and the server 200 may transmit/receive data for the collaborative editing file sharing system according to the present disclosure to/from each other through the network 300.

The user terminal 100 may include a personal computer (PC), a note book, a mobile terminal, a smart phone, a tablet PC, and the like possessed by a user and may include all types of terminals which are accessible to a wired/wireless network.

The user terminal 100 in the present disclosure may be a terminal which may create and edit a document through an external input device (a keyboard, a mouse, etc.) or a touch. Further, the user terminal 100 may display on a screen a screen associated with at least one program according to a signal transmitted from the server 200.

The server 200 may include, for example, a predetermined type of computer system or computer device such as a microprocessor, a mainframe computer, a digital processor, a portable device, and a device controller.

The server 200 in the present disclosure may be a server that provides to the user terminal a platform associated with at least one program which allows at least one user to create, modify, and/or read predetermined contents including a document, and the like through the user terminal 100. However, at least one program is not limited to the program associated with the document and a program associated with a predetermined type of modifiable and/or readable file may also be included in the scope of the present disclosure.

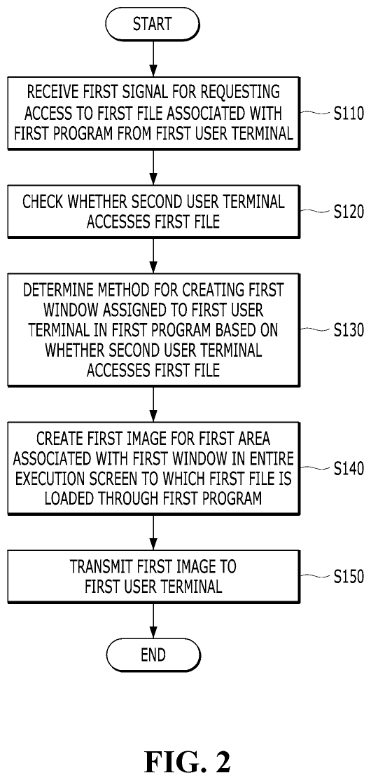

Meanwhile, the server 200 may execute at least one program. Here, at least one program may be a program associated with at least one file which the user executes through the user terminal 100. Further, the server 200 may convert at least one area of screen areas by executing at least one file into an image and transmit the image to the user terminal 100. Hereinafter, an operation in which the server 200 converts the area associated with at least one file into the image and transmits the image to the user terminal 100 will be described below in detail with reference to FIG. 2.

The server 200 may include a processor 210, a storage unit 220, and a communication unit 230. However, components described above are not required in implementing the server 200 and the server 200 may thus have components more or less than components listed above. Here, respective components may be configured as separate chips, modules, or devices and may be included in one device.

The processor 210 may generally process an overall operation of the server 200. The processor 210 processes a signal, data, information, and the like input or output through the components or drives the application program stored in the storage unit 220 to provide or process information or a function appropriate for the user.

Meanwhile, the storage unit 220 may include a memory and/or a persistent storage. The memory may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 220 may store any type of information created or determined by the processor 210 or any type of information received by the communication unit 230.

The communication unit 230 may include one or more modules which enable communication between the server 200 and the communication system, between the server 200 and the user terminal 100, or between the server 200 and the network 300.

The communication unit 230 may include at least one of a mobile communication module, a wired Internet module, and a wireless Internet module.

In the present disclosure, the network 300 may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network 300 presented herein may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network 300 may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth.

The techniques described in the present specification may also be used in other networks in addition to the aforementioned networks.

Meanwhile, in some exemplary embodiments of the present disclosure, the server 200 may receive from the user terminal 100 a first signal for requesting an access to a first file associated with at least one program. Upon receiving the first signal, the server 200 may execute at least one program associated with the first file in response to the first signal. In addition, the server 200 may load the first file through at least one program executed. Upon loading the first file, the server 200 may create an image for at least a partial area of an execution screen associated with the first file. In addition, the server 200 may transmit the created image for at least the partial area to the user terminal 100.

Hereinafter, referring to FIG. 2, a method for providing the collaborative editing file to the user terminal 100 by the server 200 will be described below in detail.

FIG. 2 is a flowchart for describing an example of a method for providing a collaborative editing file to a user terminal by a server according to some exemplary embodiments of the present disclosure.

Referring to FIG. 2, the processor 210 of the server 200 may receive the first signal for requesting the access to the first file associated with the first program from a first user terminal 100a through the communication unit 230 (S110).

Here, the first program may be at least one program capable of editing any type of file including a document and/or an image. Further, the first program may be a program which is not executed by the first user terminal 100a.

For example, the first program may not be installed in the first user terminal 100a. As another example, the first program may be a program including a format which is not supported by the first user terminal 100a.

The first file may be a file associated with the first program. That is, the first file may be a file which may be loaded only through the first program.

Meanwhile, when the processor 210 of the server 200 receives the first signal, the processor 210 may check whether a second user terminal 100b is accessing the first file (S120).

Specifically, the processor 210 may recognize that the second user terminal 100b is accessing the first file when the first file is being modified through the second user terminal 100b.

However, an operation of confirming whether the second user terminal 100b is accessing the first file by the processor 210 is not limited only to the second user terminal 100b, and the processor 210 may check whether at least one user terminal is accessing the first file.

Meanwhile, the processor 210 of the server 200 may determine a method for creating the first window assigned to the first user terminal 100a in the first program based on whether the second user terminal 100b is accessing the first file (S130).

Here, the first window may mean at least one window associated with the first program.

Specifically, the processor 210 may execute the first program associated with the first file. In addition, the processor 210 may create the first window using at least one function included in the first program. In addition, the processor 210 may assign the created first window to the first user terminal 100a.

As an example, the processor 210 may be requested to access the first file from the second user terminal 100b prior to receiving the first signal. In addition, the processor 210 may assign the first window to the second user terminal 100b by executing the first program associated with the first file. In this case, the processor 210 may create a second window through at least one function included in the first program. In addition, the processor 2 may assign the created second window to the first user terminal 100a. For example, when the second user terminal 100b is currently accessing the first file which the first user terminal 100a wants to access, the second window (i.e., a new window) different from the first window associated with the first file accessed by the second user terminal 100b may be assigned to the first user terminal 100a. Accordingly, since the new assigned window is provided to the user terminal in the form of an image, an interaction between the new window of the image form and the user terminal may be performed, and changed information in the new window may be transferred to the server 200 through the interaction. Therefore, execution (e.g., cooperative editing, reading, and the like) of the first file may be enabled even if the user terminal does not have a separate program associated with the first file.

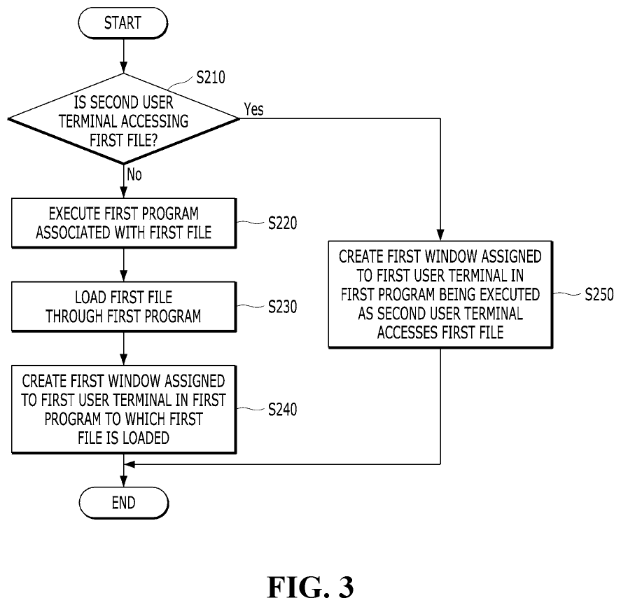

Hereinafter, a detailed method in which the processor 210 creates the first window in the first program will be described below through FIG. 3.

The processor 210 of the server 200 may create a first image 511 for a first area 510 associated with the first window in an entire execution screen 500 to which the first file is loaded through the first program (S140).

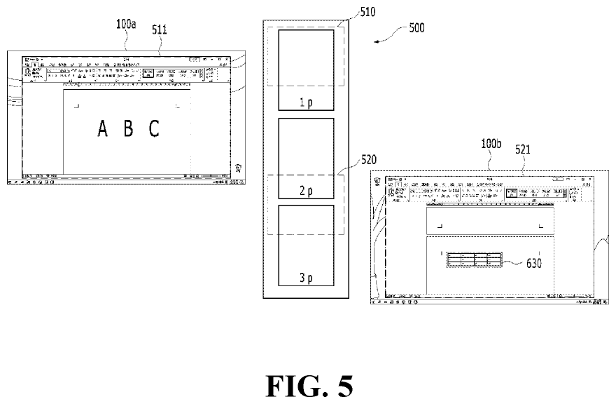

Here, the entire execution screen 500 (see FIG. 5) may be an entire area associated with the first file.

The first area 510 (see FIG. 5) may be at least a partial area of the entire execution screen 500 to which the first file is loaded.

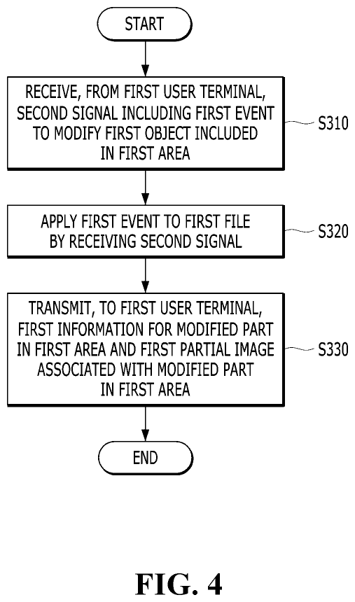

Specifically, for example, the first file may be a document file having a plurality of pages. In addition, the first area 510 may be at least a partial area of the entire execution screen 500 which may be displayed in the first window associated with the first user terminal 100a among the plurality of pages included in the first file. Hereinafter, the entire execution screen and the first area 510 will be described below in detail with reference to FIGS. 4 and 5.

The first file is not limited to the document file having the plurality of pages.

For example, the first file may include one page which may be scrolled up or down without distinguishing the page. As another example, the first file may be a document file divided into a slide format in which a left or right direction exists.

Meanwhile, the first image 511 (see FIG. 5) may be an image of a format executable by the first user terminal 100a. That is, the first image 511 may be data of a format which may be displayed even when the first program associated with first file is not installed in the first user terminal 100a. Hereinafter, the first image 511 will be described below in detail with reference to FIGS. 4 and 5.

The processor 210 of the server 200 may control the communication unit 230 to transmit the created first image 511 to the first user terminal 100a (S150).

Meanwhile, the first user may edit the first image 511 displayed on the first user terminal 100a through the first user terminal 100a.

Specifically, the first image 511 may include at least one editable object. Here, the at least one object may be at least one of a table, an image, a chart, or text. However, at least one object is not limited to the above example.

The first user may modify at least one object through the first user terminal 100a. In this case, the processor 210 may receive a second signal including a first event such as deletion of at least one object from the first user terminal 100a through the communication unit 230. Here, the event refers to an interaction (e.g., modification, addition, movement, deletion, etc.) with the object performed in the user terminal.

As the processor 210 receives the second signal, the processor 210 may apply the first event to the first file. In addition, the processor 210 may create at least a partial area of the first file to which the first event is applied as the image. In addition, the processor 210 may control the communication unit 230 to transmit the created image to the first user terminal 100a.

Hereinafter, a method for processing, when the processor 210 receives an event of modifying at least one object from the user terminal 100 through the communication unit 230, the event will be described below with reference to FIG. 4.

FIG. 3 is a flowchart for describing an example of a method for creating a first window that is assigned to a first user terminal according to some exemplary embodiments of the present disclosure in a first program.

According to some exemplary embodiments of the present disclosure, the processor 210 of the server 200 may receive the first signal for requesting the access to the first file associated with the first program from the first user terminal 100a through the communication unit 230. Further, the processor 210 may check whether the second user terminal 100b is accessing the first file.

Meanwhile, referring to FIG. 3, when the second user terminal 100b is not accessing the first file (No in S210), the processor 210 of the server 200 executes the first program associated with the first file (S220).

Specifically, the processor 210 may recognize that the second user terminal 100b does not access the first file when the second user terminal 100b is not modifying the first file. In this case, the processor 210 may not execute the first program associated with the first file.

Therefore, the processor 210 may execute the first program in order to load the first file.

Meanwhile, the processor 210 may load the first file through the first program.

Here, loading the first file may be an operation for enabling the processor 210 to modify the first file through the first program.

For example, the processor 210 may insert any type of object(s) including a text, a table, a chart, or a figure into the first file loaded through the first program.

The processor 210 of the server 200 may create the first window assigned to the first user terminal 100a in the first program to which the first file is loaded (S240).

Specifically, the processor 210 may create the first window by executing the first program associated with the first file. In addition, the processor 210 may assign the created first window to the first user terminal 100a. For example, assigning the first window to the first user terminal 100a may include designating the first window to be accessed by the first user terminal 100a by the processor 210 of the server 200. The first user terminal 100a to which the first window is assigned may receive the first image 511 corresponding to the first window. The first user terminal 100a will perform the interaction with objects in the first window through the received first image 511 corresponding to the first window. Events created according to the interaction with the first window are recognized by the server 200 to edit the first file by the first user terminal 100a.

According to some exemplary embodiments of the present disclosure, when the second user terminal 100b is not accessing the first file, the processor 210 of the server 200 may execute the first program associated with the first file.

Specifically, the processor 210 may be in a state in which the first program associated with the first file is executed in advance.

As an example, just after the processor 210 is booted, the processor 210 may execute the first program.

As another example, the processor 210 may execute the first program associated with the first file based on a signal received from a third user terminal. In addition, the processor 210 may create a third window and assign the created third window to the third user terminal. In addition, the processor 210 may not terminate the first program even when the third user terminal terminates the access to the first file.

The processor 210 may receive the first signal for requesting the access to the first file associated with the first program from the first user terminal 100a through the communication unit 230. In this case, the processor 210 may load the first file through the first program which is executed in advance.

Meanwhile, when the processor 210 executes the first program associated with the first file in advance, a time required for loading the first file may be shortened. Accordingly, the processor 210 may perform an operation corresponding to the first signal received from the first user terminal 100a through the communication unit 230 a little earlier.

The processor 210 of the server 200 may recognize the first program executed as the second user terminal 100b accesses the first file when the second user terminal 100b is accessing the first file. In addition, the processor 210 may create the first window assigned to the first user terminal 100a in the first program (Yes in S210).

That is, the processor 210 may receive the signal for requesting the access to the first file associated with the first program from the second user terminal 100b through the communication unit 230 earlier than the first signal received from the first user terminal 100a. In this case, the processor 210 may recognize the first program associated with the first file which is already executed based on the signal received from the second user terminal 100b. In addition, the processor 210 may create the first window by using a new window function included in the first program and assign the created first window to the first user terminal 100a.

Meanwhile, when the server 200 intends to share a first collaborative editing file with at least one user terminal 100 through the aforementioned operations, the server 200 may not include a separate program (e.g., Google Docs program of Google) including a real-time collaborative editing function.

Specifically, the first program executed as the processor 210 of the server 200 receives the first signal from the first user terminal 100a through the communication unit 230 may be a legacy program (e.g., a Microsoft word documents program used locally) not including the real-time collaborative editing function used in the related art. Further, the processor 210 may create the first window by using at least one function included in the first program (e.g., legacy program) and create the first image 511 associated with the created first window. In addition, the processor 210 may control the communication unit 230 to transmit the first image 511 to the first user terminal 100a.

That is, since the processor 210 of the server 200 transmits/receives the first window associated with the first file to/from the first user terminal 100a in the form of the image, the processor 210 of the server 200 may not include a separate program including the real-time collaborative editing function.

Meanwhile, the processor 210 may receive a signal including the event such as modification of at least a part of the first image 511 and the second image 521 from the user terminal 100 through the communication unit 230. Here, the event refers to an interaction (e.g., modification, addition, movement, and deletion) with the object in the first image 511 performed by the first user terminal 100a.

Hereinafter, contents associated with an operation of the processor 210 which receives the signal including the event such as the modification of the image from the user terminal 100 through the communication unit 230, etc., will be described with reference to FIG. 4.

FIG. 4 is a flowchart for describing an example of an operation of a server which modifies a first image related to a first file according to some exemplary embodiments of the present disclosure.

Referring to FIG. 4, the processor 210 of the server 200 may receive a second signal including a first event of modifying a first object 600 included in the first area 510 from the first user terminal 100a through the communication unit 230 (S310).

Here, the first area 510 may be at least a partial area of the entire execution screen 500 to which the first file is loaded. However, the first area 510 is not limited thereto and may be the entire execution screen 500.

The first object 600 may be at least one object included in the first area 510.

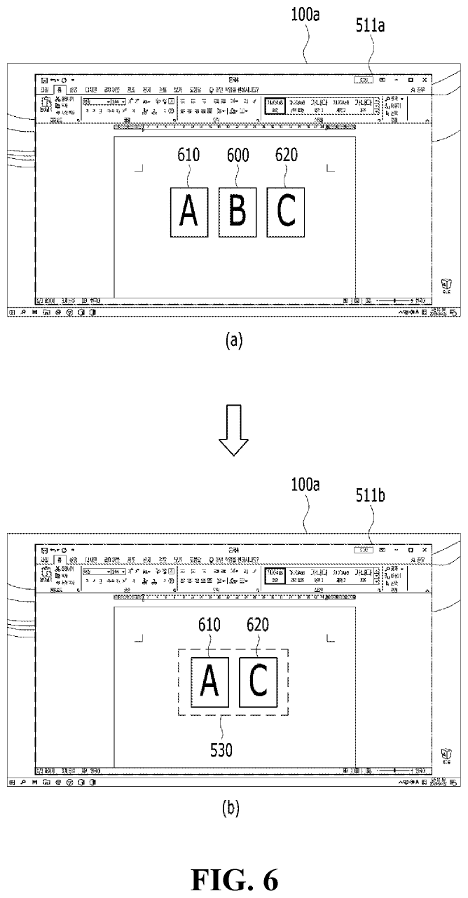

Specifically, the first object 600 may be at least one of the text, the table, the image, or the chart. As an example, the first object 600 may be a ribbon for executing at least one command included in the first program. However, the first object 600 is not limited to the above example. Further, a detailed example associated with the first object 600 will be described below through FIGS. 5 and 6.

In the present disclosure, the first event may include at least one of an event to edit the first object 600, an event to move the position of the first object 600, or an event to delete the first object 600. Here, the event to edit the first object 600 may be an event to edit at least one of the text, the table, or the chart. Similarly, the event to move the position of the first object 600 and the event to delete the first object 600 may include at least one of an event to move or delete at least one of the text, the table, or the chart. However, the first event is not limited to the above example.

In the present disclosure, for convenience of description, it will be assumed that the first object 600 is the object associated with the text and the first object will be described below. However, the first object 600 may be at least one of the text, the table, the image, or the chart as described above and is not limited thereto.

Meanwhile, as the processor 210 of the server 200 receives the second signal, the processor 210 may apply the first event to the first file (S320).

Specifically, the processor 210 may recognize at least one event of editing, moving, or deletion included in the first event. The processor 210 of the server 200 may recognize changed contents (i.e., first event) for an object(s) performed by the first user terminal 100a based on the first event received from the first user terminal 100a. The processor 210 of the server 200 may recognize the first event or an operation corresponding to the first event based on positional information and event attribute information (e.g., modifying, deleting, moving, etc.) corresponding to the first event received from the first user terminal 100a.

Hereinafter, it will be assumed and described that the first event received from the first user terminal 100a by the communication unit 230 is an event to delete the first object 600.

For example, the processor 210 may receive the first event through the communication unit 230. In addition, the processor 210 may recognize the first event as an event to delete the first object 600. In this case, the processor 210 may apply an operation corresponding to the first event to the first file. That is, the processor 210 may delete a text corresponding to the first object 600 in the first file through the first program.

Specifically, for example, the first object 600 included in the first area 510 may be “B”. Further, the processor 210 may receive the first event to delete the first object 600 from the first user terminal 100a through the communication unit 230. In addition, the processor 210 may recognize the text corresponding to the first object 600 in the first file. In this case, the processor 210 may delete a text “B” corresponding to the first object 600 recognized in the first file. That is, the processor 210 may modify the first object 600 included in the first area 510 in the entire execution screen associated with the first file.

Meanwhile, the processor 210 of the server 200 may control the communication unit 230 to transmit first information on a modified part in the first area 510 to the first user terminal 100a. Further, the processor 210 may control the communication unit 230 to transmit a first partial image 530 associated with the modified part in the first area 510 to the first user terminal 100a (S330).

Here, the first information may be information including at least one of positional information, size information, and format information in which the modified part is disposed in the first area 510. However, the first information is not limited thereto.

Here, the first partial image 530 may be a part associated with a part where the first object 600 is modified in the first area 510. However, the first partial image 530 is not limited thereto.

As the processor 210 recognizes the first partial image 530 associated with the modified part, data to be transmitted through the communication unit 230 may be minimized. Accordingly, the processor 210 may perform an operation corresponding to the second signal received from the first user terminal 100a in near real time.

According to some exemplary embodiments of the present disclosure, the processor 210 of the server 200 may recognize that the second user terminal 100b is accessing the first file. Further, the processor 210 may recognize whether the image displayed in the second user terminal 100b is the first image 511 associated with the first area 510. In this case, the processor 210 may control the communication unit 230 to transmit the first information on the modified part in the first area 510 to the second user terminal 100b. Further, the processor 210 may control the communication unit 230 to transmit the first partial image 530 associated with the modified part in the first area 510 to the first user terminal 100a.

Therefore, a situation in which the first user modifies the first file through the first user terminal 100a may be displayed on the second user terminal 100b in almost near real time.

FIG. 5 is a diagram for describing an example of an area that may be displayed in a user terminal according to some exemplary embodiments of the present disclosure.

Referring to FIG. 5, the first area 510 and the second area 520 may be at least partial areas of the entire execution screen 500. However, at least one area included in the entire execution screen 500 is not limited to the first area 510 and the second area 520.

Here, the entire execution screen 500 may be a screen created when the processor 210 of the server 200 executes the first program associated with the first file.

Specifically, for example, the first file may be a document file constituted by three pages. In this case, the entire execution screen 500 may include a ribbon, a menu window, or three pages of the program associated with the first file. However, the entire execution screen 500 is not limited to the above example.

The first area 510 may be at least a partial area of the entire execution screen 500.

Specifically, the first area 510 may be an area which may be displayed on the first window associated with the first user terminal 100a. Further, the first area 510 may be changed by the first user terminal 100a of the first user.

For example, when the processor 210 receives a signal indicating that the processor 210 moves to a lower side of the first area 510 marked in FIG. 5 from the first user terminal 100a through the communication unit 230, the first area 510 may move to the lower side.

The second area may be at least a partial area different from the first area 510 in the entire execution screen 500.

Specifically, the second area 520 may be an area which may be displayed on the second window associated with the second user terminal 100b. Further, the second area 520 may be changed by the second user terminal 100b of the second user.

However, the first area 510 and the second area 520 are not limited to the above example.

Meanwhile, the first image 511 may be the image for the first area 510.

Specifically, the processor 210 may receive a signal for requesting displaying the first area 510 from the first user terminal 100a through the communication unit 230. In this case, the processor 210 may control the communication unit 230 to convert the first area 510 into the first image 511 and transmit the first image 511 to the first user terminal 100a.

The second image 521 may be the image for the second area 520.

Specifically, the processor 210 may receive a signal for requesting displaying the second area 520 from the first user terminal 100a through the communication unit 230. In this case, the processor 210 may control the communication unit 230 to convert the second area 520 into the second image 521 and transmit the second image 521 to the second user terminal 100b.

However, the first image 511 and the second image 521 are not limited to the above example.

Meanwhile, the first area 510 and the second area 520 may include at least one object.

Specifically, the second image 521 created through the second area 520 may include a fourth object 630.

The fourth object 630 may be at least one table included in the second image 521. In addition, at least one cell included in the table of the fourth object 630 may be at least one partial image. Alternatively, all cells constituting the fourth object 630 may be at least one partial image.

The fourth object 630 may be modified based on at least one event received from the second user terminal 100b.

Hereinafter, an example of a method for modifying at least one object displayed in the user terminal 100 will be described below with reference to FIG. 6.

FIG. 6 is a diagram for describing an example of a method for modifying an object by a user terminal according to some exemplary embodiments of the present disclosure.

Referring to FIG. 6, a first image 511a of the first user terminal 100a may include a first object 600, a second object 610, a third object 620, or a first partial image 530. However, what is included in the first image 511a is not limited to the first object 600, the second object 610, the third object 620, or the first partial image 530.

The first object 600, the second object 610, or the third object 620 may be at least one text.

As an example, the first object 600 may include at least one of positional information, size information, and format information disposed in the first image 511a associated with the first file. Further, the first object 600 may be edited, moved, or deleted.

Specifically, for example, the first object 600 may be deleted from the first user through the first user terminal 100a. Further, the first user terminal 100a receiving deletion of the first object 600 from the first user may transmit to the server 200 a second signal including a first event to delete the first object.

As the processor 210 of the server 200 receives the first event, the processor 210 may delete the first object 600 included in the entire execution screen 500 through the first program associated with the first file. Further, the processor 210 may modify the second object 610 and the third object 620 by deleting the first object 600.

For example, when the first object 600 is deleted, the processor 210 may move the third object 620 to a position where the first object 600 exists. As another example, when the first object 600 is deleted, the processor 210 may move the second object 610 and the third object 620 in a direction in which the first object 600 is positioned gradually. However, modification of the second object 610 or the third object 620 with deletion of the first object 600 is not limited to the above example.

Meanwhile, when the processor 210 applies the first event to the first file, the processor 210 may create an area associated with the modified part as the first partial image 530. In addition, the processor 210 may control the communication unit 230 to transmit the first partial image 530 to the first user terminal 100a.

Here, the first partial image 530 may be an image for a part including the second object 610 and the third object 630 in the modified first image 511b.

The processor 210 may create first information for the modified part in link with controlling the communication unit 230 to transmit the first partial image 530 to the first user terminal 100a.

Specifically, the processor 210 may include at least one of the positional information, the size information, and the format information in which the first partial image 530 is disposed in the first area 510 to create the first information. In addition, the processor 210 may control the communication unit 230 to transmit the created first information to the first user terminal 100a.

Accordingly, the first image 511b in which the first partial image 530 is updated may be displayed in the first user terminal 100a.

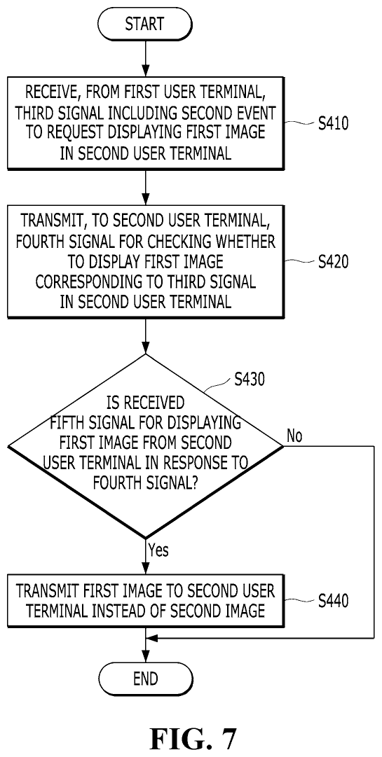

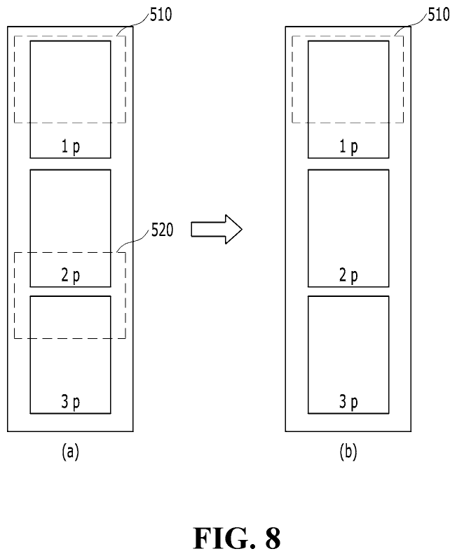

FIG. 7 is a flowchart for describing an example of a method for transmitting a first image to a second user terminal according to a request of a first user by a server according to some exemplary embodiments of the present disclosure. FIG. 8 is a diagram for describing an example of a method for changing an area transmitted to a second user terminal by a server according to some exemplary embodiments of the present disclosure.

Referring to FIG. 7, the processor 210 of the server 200 may receive a third signal including the second event for requesting displaying the first image 511 in the second user terminal 100b from the first user terminal 100a through the communication unit 230 (S410).

Here, the first image 511 may be an image associated with the first area 510 being displayed in the first user terminal 100a. In addition, the first image 511 may be an image associated with the first area 510 being not displayed in the second user terminal 100b. However, the first area 510 is not limited thereto and at least a partial area of the first area 510 may be displayed in the second user terminal 100b.

According to some exemplary embodiments of the present disclosure, the processor 210 may control the communication unit 230 to transmit the first image 511 to the second user terminal 100b instead of the second image 521 by receiving the third signal.

Specifically, the processor 210 may transmit the first image 511 through the communication unit 230 so as to display the first image 511 being displayed in the first user terminal 100a in the second user terminal 100b. However, the present disclosure is not limited thereto and the communication unit 230 may transmit the first image 511 to at least one user terminal which is accessing the first file.

Meanwhile, the processor 210 may control the communication unit 230 to transmit a fourth signal for checking whether to display the first image 511 corresponding to the third signal in the second user terminal 100b to the second user terminal 100b (S420).

Specifically, the processor 210 may recognize whether the second user terminal 100b is to display the first image 511 through the fourth signal.

For example, when the processor 210 receives a response signal to display the first image 511 from the second user terminal 100b in response to the fourth signal, the processor 210 may recognize that the second user terminal 100b displays the first image 511.

According to some exemplary embodiments of the present disclosure, the processor 210 may recognize whether the second area 520 being displayed in the second user terminal 100b matches the first area 510 being displayed in the first user terminal 100a.

Specifically, when the second image being displayed in the second user terminal 100b is the first image 511, the processor 210 may recognize that the first image is being displayed in the second user terminal 100b.

In this case, the processor 210 may not create the fourth signal for checking whether to display the first image 511.

On the contrary, when the processor 210 recognizes that the second image 521 being displayed in the second user terminal 100b is different from the first image 511, the processor 210 may create the fourth signal.

Meanwhile, when the processor 210 receives a fifth signal from the second user terminal 100b through the communication unit 230 (Yes in S430), the processor 210 may transmit the first image 511 to the second user terminal 100b instead of the second image 521 (S440). Here, the fifth signal may be a signal to display the first image 511 in response to the fourth signal.

For example, referring to FIG. 8A, the first area 510 may be an area associated with the first image 511 being displayed in the first user terminal 100a. In addition, referring to FIG. 8B, the first area 510 may be an area associated with the first image 511 being displayed in the first user terminal 100a and the second user terminal 100b.

That is, as the processor 210 receives the fifth signal through the communication unit 230, the processor 210 may cause the same area as the first user terminal 100a to be displayed in the second user terminal 100b.

Meanwhile, when the communication unit 230 receives a signal not to display the first image from the second user terminal 100b, the communication unit 230 may not transmit the first image 511 to the second user terminal 100b.

As an example, when the processor 210 may not receive the fifth signal from the second user terminal 100b (No in S430), the processor 210 may not transmit the first image 511 to the second user terminal 100b.

As another example, when the processor 210 may not receive the fifth signal from the second user terminal 100b for a predetermined time (No in S430), the processor 210 may control the communication unit 230 to retransmit the fourth signal. Here, the predetermined time may be prestored in the storage unit 220.

Meanwhile, when the processor 210 provides sharing of the collaborative editing document to the second user terminal 100b based on the third signal received from the first user terminal 100a as described above, efficiency of sharing of the collaborative editing document of the first user and the second user may be increased.

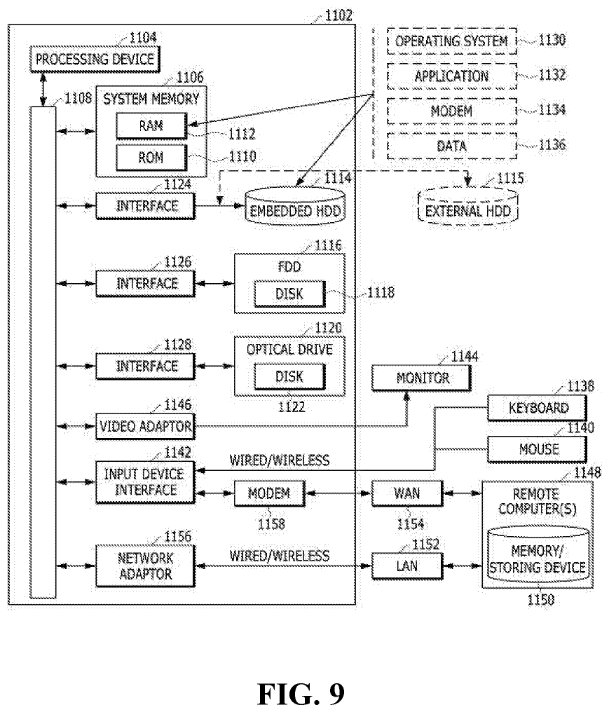

FIG. 9 is a general schematic view of an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or recorded in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes computer programs or media which are accessible by a predetermined computer-readable device. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer program stored in a non-transitory computer readable medium, wherein the computer program includes commands which cause a computer to execute steps, the steps comprising:
receiving a first signal requesting access to a first file associated with a first program from a first user terminal;
if the first signal is received, checking whether a second user terminal is accessing the first file;
determining a method for generating a first window in the first program, wherein the first window is assigned to the first user terminal, based on whether the second user terminal is accessing the first file;
generating a first image for a first area associated with the first window among an entire execution screen in which the first file is loaded through the first program; and
transmitting the first image to the first user terminal.

2. The computer program of claim 1, wherein the determining a method for generating a first window in the first program comprises:
if the second user terminal is not accessing the first file, executing the first program associated with the first file;
loading the first file through the first program; and
generating the first window to be assigned to the first user terminal in the first program loaded with the first file.

3. The computer program of claim 1, wherein the determining a method for generating a first window in the first program comprises:
if the second user terminal is accessing the first file, generating the first window to be assigned to the first user terminal in the first program being executed as the second user terminal accesses the first file.

4. The computer program of claim 3, wherein the steps further comprise:
transmitting a second image of a second area associated with a second window assigned to the second user terminal among the entire execution screens to the second user terminal.

5. The computer program of claim 1, wherein the steps further comprise:
receiving a second signal including a first event modifying a first object included in the first area from the first user terminal; and
applying the first event to the first file upon receiving the second signal.

6. The computer program of claim 5, wherein the applying the first event to the first file upon receiving the second signal comprises:
modifying the first object included in the entire execution screen.

7. The computer program of claim 5, wherein the steps further comprise:
if the first event is applied in the first file, transmitting first information about a modified section within the first area and a first section image associated with the modified section within the first area to the first user terminal.

8. The computer program of claim 7, wherein the first information comprises information related to at least one of size, format or position in which the modified section is disposed in the first area.

9. The computer program of claim 5, wherein the first event comprises at least one of an event editing the first object, an event moving the first object or an event deleting the first object.

10. The computer program of claim 4, wherein the steps further comprise:
receiving a third signal including a second event requesting to display the first image on the second user terminal from the first user terminal; and
transmitting the first image instead of the second image to the second user terminal upon receiving the third signal.

11. The computer program of claim 10, wherein the transmitting the first image instead of the second image to the second user terminal comprises:
transmitting a fourth signal for confirming to the second user terminal whether to display the first image corresponding to the third signal to the second user terminal; and
when receiving a fifth signal to display the first image in response to the fourth signal from the second user terminal, transmitting the first image instead of the second image to the second user terminal.

12. A server, comprising:
a network unit receiving a first signal requesting access to a first file associated with a first program from a first user terminal; and
a processor checking whether a second user terminal is accessing the first file when the first signal is received;
wherein the processor is further configured to:
determine a method for generating a first window in the first program;
generate a first image for a first area associated with the first window among an entire execution screen in which the first file is loaded through the first program; and
control the network unit to transmit the first image to the first user terminal,
wherein the first window is assigned to the first user terminal based on whether the second user terminal is accessing the first file.

13. The server of claim 12, wherein the processor is further configured to:
if the second user terminal is not accessing the first file, execute the first program associated with the first file,
load the first file through the first program, and
generate the first window to be assigned to the first user terminal in the first program loaded with the first file.

14. The server of claim 12, wherein the processor is further configured to:
if the second user terminal is accessing the first file, generate the first window to be assigned to the first user terminal in the first program being executed as the second user terminal accesses the first file.

15. The server of claim 14, wherein the processor is further configured to:
control the network unit to transmit a second image of a second area associated with a second window assigned to the second user terminal among the entire execution screens to the second user terminal.

16. The server of claim 12, wherein the processor is further configured to:
receive a second signal including a first event modifying a first object included in the first area from the first user terminal through the network unit, and
apply the first event to the first file upon receiving the second signal.

17. The server of claim 16, wherein the processor is further configured to:
control the network unit to transmit first information about a modified section within the first area and a first section image associated with the modified section within the first area to the first user terminal if the first event is applied in the first file.

18. The server of claim 17, wherein the first information comprises information related to at least one of size, format or position in which the modified section is disposed in the first area.

19. The server of claim 16, wherein the first event comprises at least one of an event editing the first object, an event moving the first object or an event deleting the first object.

20. The server of claim 15, wherein the processor is configured to:
receive a third signal including a second event requesting to display the first image on the second user terminal from the first user terminal through the network unit,
control the network unit to transmit a fourth signal for confirming to the second user terminal whether to display the first image corresponding to the third signal to the second user terminal, and
control the network unit to transmit the first image instead of the second image to the second user terminal when receiving a fifth signal to display the first image in response to the fourth signal from the second user terminal.
